(19) United States
(12) Patent Application Publication
(10) Pub. No.: US 2014/0116803 A1
(43) Pub. Date: May 1, 2014

(54) HOOK ELEVATOR SYSTEM FOR PROVIDING ASCENDING SUPPORT ALONG ANY NUMBER OF LOAD BEARING LIMBS

(71) Applicants: Michael Overbaugh, Houghton Lake, MI (US); Svetlana Overbaugh, Houghton Lake, MI (US)

(72) Inventors: Michael Overbaugh, Houghton Lake, MI (US); Svetlana Overbaugh, Houghton Lake, MI (US)

(21) Appl. No.: 13/665,988

(22) Filed: Nov. 1, 2012

(51) Int. Cl. E06C 7/00; E06C 1/56

(52) U.S. Cl. 182/8

(57) ABSTRACT

A hook elevator system, kit and method for assisting an individual in ascending a series of horizontally ascending tree limbs. One or more limb engaging hooks are provided along with a pole for elevating a given hook above the user's head in order to access a given limb. A rope extends from the hook to a harness worn by the user for enabling the user to winch up to the hook, such as from a ground location, with the hook being removed and elevated to a further ascending limb by the wearer once he/she has reached the support of the initial limb. Alternatively, additional hooks can provide additional flexibility in allowing the user to move from limb to limb, and which facilitates the user's ability to access an elevated and supported location of the tree for setting up a tree stand/platform.

### FIELD OF THE INVENTION

The present invention is an assembly, kit and method for mechanically elevating an individual, including disabled hunters or individuals, in a progressively elevating fashion from limb to limb of a tree, and without having to climb the tree.

### BACKGROUND OF THE INVENTION

The prior art is documented with examples of elevation assist devices for use by individuals in scaling vertical distances. A first example of this is depicted in the remote attachable/release hook apparatus depicted in U.S. Pat. No. 6,715,809, to Thompson, in which a hollow braid rope or cable which is threaded through a tail, such as by a swivel, associated with the hook and exhibiting unidirectional properties. The hook assembly exhibits a “C” shaped configuration with rounded outside edges and an attached middle leg.

U.S. Pat. No. 6,022,059, to Regamey, teaches a method and kit apparatus for temporarily securing ropes to trees or other tree standing vertical supports including a pair of elongated poles, a yolk attachable attachable to a first of the poles, and a rope configuration supported upon radially projecting arms associated with an upper end of the yolk. The rope includes a second extended loop concurrently supported upon the second pole during sliding upward displacement along a vertical support, following which the rope loops are tightened and the poles removed such that the rope is held by the yolk at the vertical support.

U.S. Pat. No. 5,704,669, to Clark, teaches a portable tree swing system for installing one or more cables upon tree branches and which includes an elongated pole with a hoist line coaxially threaded through the pole from bottom to top. A free end of the hoist line is attached to a closable fastener with a supply of the line is wound onto a storage device or spool disposed at or near the bottom of the pole. A loop collar is connected to a top end of a support cable, with a retrieval collar connected to the support cable at a position below the loop collar.

In this fashion, the hoist line is placed over an overhead object, following which an end of the hoist line is attached to the bottom end of the support cable, the support cable is hoisted over the overhead object until loop collar is disposed at eye level, and the hoist line is threaded through the running loop collar to form a running closed loop around the overhead object, following which the running closed loop is tightened around the overhead object. Removal of the support cable assembly from the overhead object occurs by pulling down on the retrieval cable until the running closed loop comes apart and fee support cable assembly falls to the ground.

### SUMMARY OF THE INVENTION

The present application teaches a hook elevator system, kit and method for assisting an individual, including such as a handicapped hunter or the like, in ascending a series of horizontally extending supports, most typically associated with a tree. The system employs one or more limb engaging hooks, a pole for elevating a given hook above the user's head in order to access a given limb, and a rope extending from the hook to a harness worn by the user for enabling the user to winch up to the hook.

In one variant, the hook can be initially attached to a first limb accessible by the user with the pole from a ground location, with the hook being removed and elevated to a further ascending limb by the wearer once he/she has reached the support of the initial limb. Alternatively, additional hooks can provide additional flexibility in allowing the user to move from limb to limb, and which facilitates the user's ability to access an elevated and supported location of the tree for setting up a tree stand/platform.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an environmental view of the hook elevator kit and assembly according to one non-limiting embodiment and illustrating an initial setup in which a limb support hook is elevated by a pole onto an elevated limb, a rope extending downwardly from the hook and engaged with a lift harness worn by the user for assisting in progressively ascending any number of limbs associated will a tree;

FIG. 2 is a successive environmental view depicting the hook in place, the pole retracted and stowed, and the user in the process of ascending via the harness to the elevated and limb supported hook;

FIG. 3 is a perspective view of a substantially “C” shaped hook according to one variant and which exhibits both a pole end receiving socket and rope engagement aperture formed into a base location of the hook;

FIG. 4 is a side plan view of a modification of a further hook similar to that depicted in FIG. 3 without the pole receiving socket, and such as which can be employed singularly or in combination with the hook of FIG. 3 for progressively ascending sequential limbs;

FIG. 5 is a rotated front view of the hook depicted in FIG. 4 and illustrating an arrangement of strengthening ribs for preventing undesirable deflection of the hook during load bearing ascension of the user;

FIG. 6 is an illustration similar to FIG. 3 of a hook according to a further potential variant;

FIG. 7 is a side plan view of the hook in FIG. 6; and

FIG. 8 is a front view of the hook of FIGS. 6-7.

### DETAILED DESCRIPTION OF THE PREFERRED EMBODIMENTS

As previously described, and with reference to the following illustrations, the present invention discloses an assembly, kit and method for mechanically elevating an individual, including either able bodied individuals as well as disabled hunters or others progressively from limb to limb of a tree, and without the individual having to climb the tree.

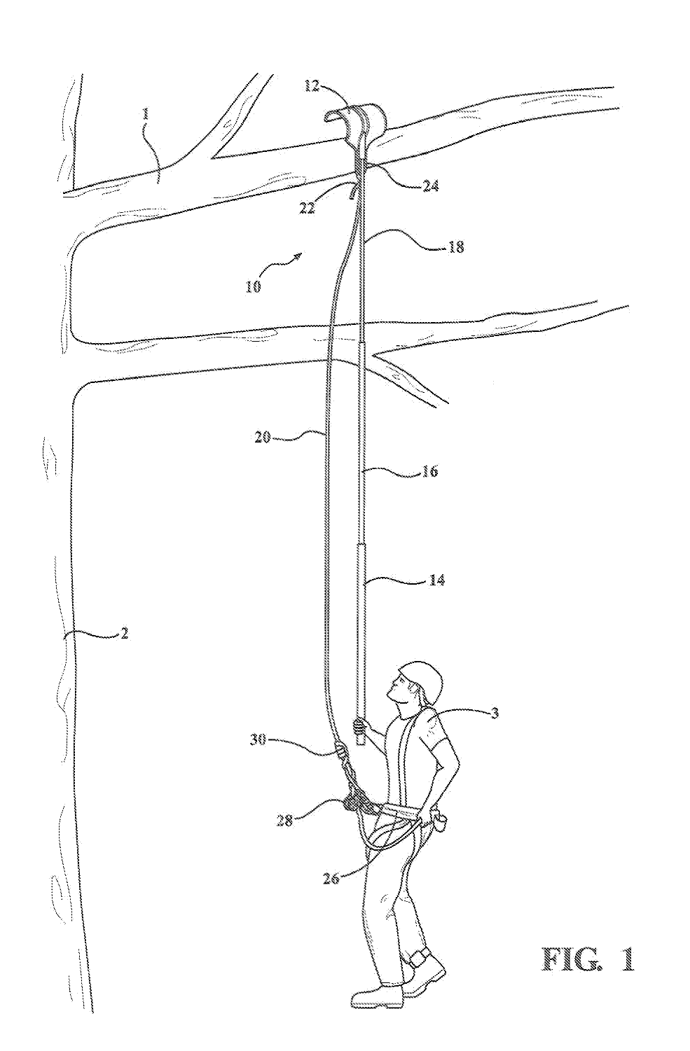

Referring initially to FIG. 1, an initial environmental view is depicted generally at 10 of the hook elevator kit and assembly according to one non-limiting embodiment. This is illustrated in one non-limiting initial setup, in which a limb support hook 12 is shown which is supported upon and elevated by a pole (typically telescopically extensible and illustrated with interconnecting sections 14, 16 and 18), such that the hook 12 is supported upon an elevated and generally horizontally extending support location, most typically a limb 1 associated with a tree 2 or other vertically extending structure which it is desirous of the user to scale.

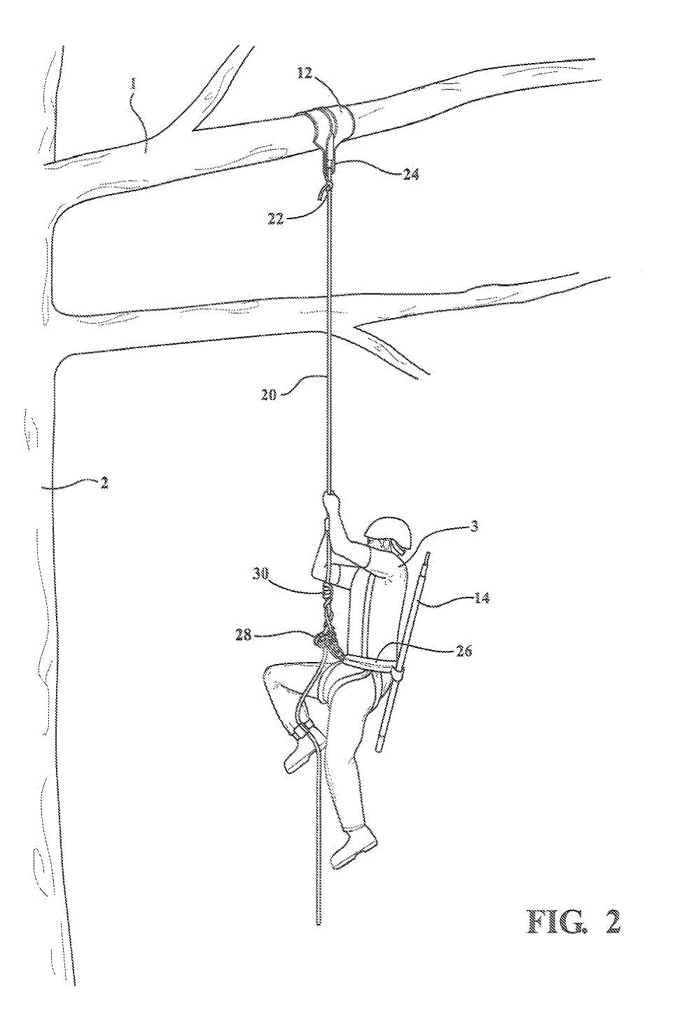

A rope 20 includes an upper end 22 knotted to an extending base 24 of the hook 12, the rope 20 extending downwardly from the hook 12 and engaged with a lift harness (defined as including a belt 26, at least one pulley 28, and a rope location 30 engaged at or through the pulley 28) worn by user 3 for assisting in progressively ascending any number of limbs 1 associated with the tree 2. FIG. 2 is a successive environmental view depicting the hook 12 in place, the pole 14 retracted and stowed, and the user 3 in the process of ascending via the harness 26, 28 and 30 to the elevated and limb supported hook 12.

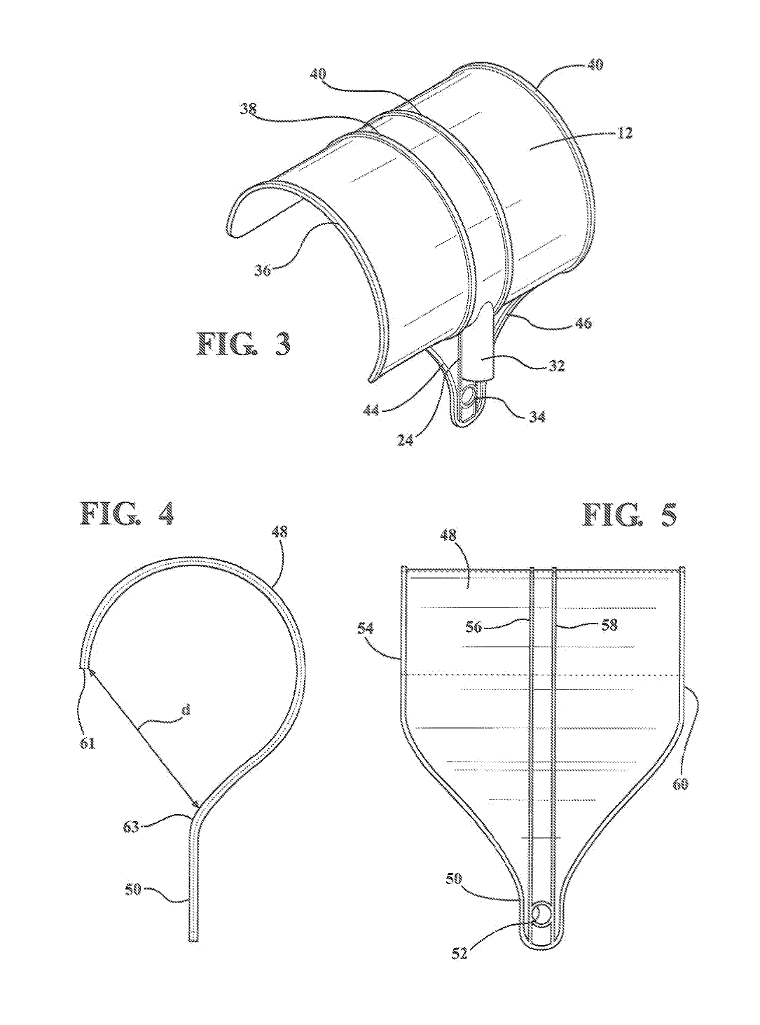

Having provided a most basic operational protocol of the system, kit and method, additional description will now be made as to the hook 12 and which, as initially illustrated in FIG. 3, exhibits in perspective view a substantially “C” shape. The extending base 24 is integrally secured to an extends downwardly from a middle adjoining location of the hook 12, and exhibits both a pole end receiving socket 32 for seating over the extending end of the uppermost telescoping pole section 18), as well as a rope engagement aperture 34 formed into a base location of the hook and through which the upper knotted end 22 is tied or otherwise engaged.

The hook 12 is constructed of any of a variety of suitable materials exhibiting the necessary properties of strength, low deflection/bending and impact resistance, among these including any suitable metal, such as aluminum, as well as any durable and sufficiently non-flexural plastic. FIG. 3 further illustrates a plurality of strengthening ribs integrally formed into the construction of the hook 12, such as which can be injection molded, stamped or otherwise formed. The ribs include those depicted at 36, 38, 40 and 42, associated with the main “C” shaped body of the hook, as well as additional strengthening ribs 44 and 46 defining (inwardly) sloping edges of the extending base 24, and which support the hook receiving socket 32 and the rope receiving aperture 34 (see closed inner perimeter edge). Without limitation, the hook construction is envisioned to exhibit the capability to support a combined user and carried equipment weight of at least 250-300 lbs. without risk of any significant deflection or flex which might otherwise place the climber in danger of falling.

FIG. 4 is a side plan view of a modification of a further hook 48 similar to that depicted in FIG. 3, and further exhibiting a downwardly extending base 50, notably without the pole receiving socket depicted in FIG. 3, however including a rope receiving aperture 52 (as further depicted in the rotated front view of FIG. 5). Additional features again include strategically located strengthening ribs 54, 56, 58 and 60 (these are hidden in the side profile phantom depiction of FIG. 4 however are best shown in FIG. 5).

A forward most extending edge 61 which defines a specified open separation distance “d” with a location 63 established with at the interface between an opposite lower edge of the “C” shape cross sectional profile and the base 50. This separation distance “d” is dimensioned to provide adequate clearance for manipulating the hook from an underneath location, such as again through the use of such as an extensible pole, and in order to position the hook in supporting engagement with an adequately sturdy limb prior to the user winching up to the hook.

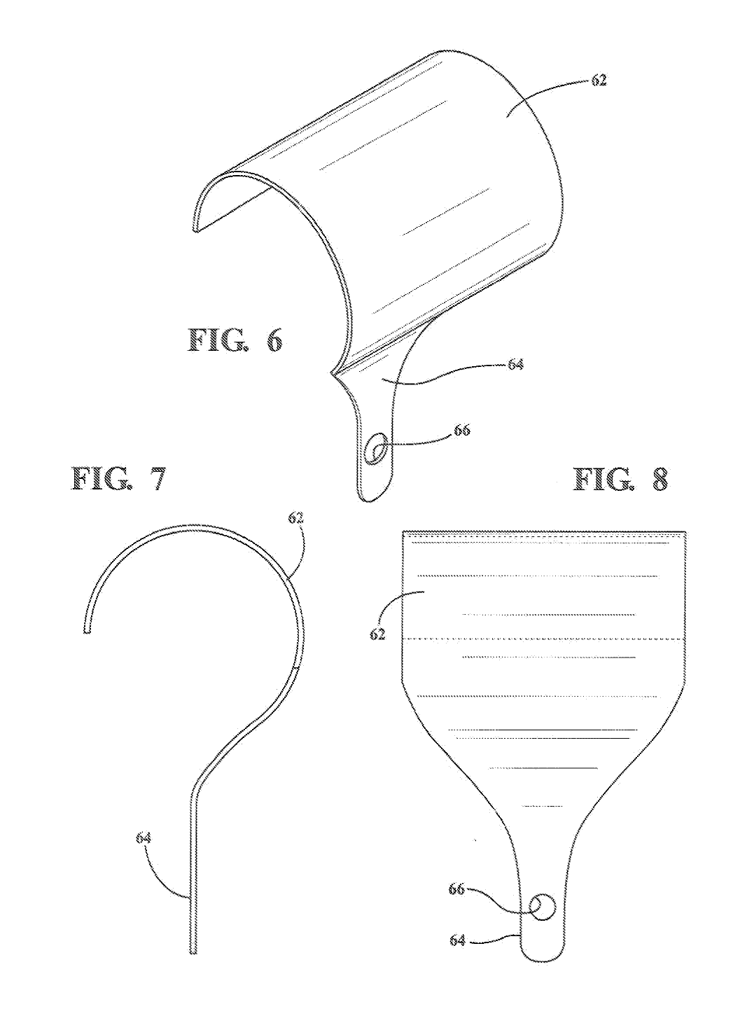

FIG. 6 is an illustration similar to FIG. 3 of a hook 62 according to a further potential variant and exhibiting a similar shape including a bottom located base 64 with located rope aperture 66, however without the provision of strengthening ribs as previously depicted. FIG. 7 is a side plan view of the hook in FIG. 6, with FIG. 8 depicting a further front view of the hook 62.

A feature of the invention is the ability of the user 3 to ascend to the limb 1 or other vertical support using either a single hook or any cumber of hooks in combination. In a most basic application, the wearer 3, such as a hunter with a tree stand or like platform (not shown), ascends to the indicated limb 1 as depicted in FIGS. 1-2 following which, and while supporting himself on the limb 1, the hook 12 is removed, placed upon the extensible end of the outermost pole section 18 (or other suitably configured and elongated pole), and extended to and placed in supporting fashion upon a higher desired limb location, following which the process is repeated.

Alternatively, the system, kit and method can contemplate the use of multiple hooks, such as according to any of the variants shown at 12, 48 or 62, and such as which can be employed singularly or in combination (such as which is further defined as being used in a tandem arrangement by which the hooks are used in succession and without necessarily dismounting a first hook before elevating and emplacing a second hook), for progressively ascending sequential limbs and for enabling the user 3 to attach or reattach a hook either while standing on the ground or when moving from limb to limb. In a multiple use variant, utilization of two or more hooks can further assist the user when moving from limb to limb and so as to provide additional mobility and flexibility.

It is further envisioned that the user's harness and pulley arrangement can be configured to allow for a pair of individual rope assemblies, thus allowing for successive ascension between limbs while remaining suspended underneath an initially supported hook and without the necessity of standing or sitting on the limb astride the initially supported hook while successively placing the second hook at a further elevated location. Such a configuration of the invention would facilitate the user's ability to effortlessly move from limb to accessible limb within the tree, and without having to climb the tree (such as which would otherwise entail driving spikes into the tree or otherwise unnecessarily damaging the tree in the course of traversing to a given location).

Having described my invention, other and additional preferred embodiments will become apparent to those skilled in the art to which it pertains, and without deviating from the scope of the appended claims.

I claim:

1. A kit assembly for assisting a user in ascending to an elevated support location, comprising:
a hook with an extending base, said hook adapted to be engaged over the support location;
a pole including a remote end engageable with said base of said hook; and
a rope secured at a first end to a further location of said base of said hook, a second end of said rope engaging a lift harness adapted to being worn by the user and, upon said hook being engaged at the support location, enabling the user to winch upwards to said hook.

2. The kit assembly as described in claim 1, said hook further comprising a substantially “C” shape in cross section.

3. The kit assembly as described in claim 1, said base of said hook further comprising a socket location for receiving said remote extending end of said pole in easily engageable/disengageable fashion.

4. The kit assembly as described in claim 1, further comprising a rope receiving aperture formed in said base of said hook.

5. The kit assembly as described in claim 2, said hook exhibiting a plurality of strengthening ribs extending along said “C” shaped cross section and said extending base.

6. The kit assembly as described in claim 1, said hook further comprising at least one of a metal or a durable and sufficiently non-flexural plastic.

7. The kit assembly as described in claim 1, said pole further comprising a plurality of individual and inter-telescoping sections.

8. The kit assembly as described in claim 1, further comprising at least one additional hook utilized in a tandem arrangement for enabling the user to successively winch up to a second and further elevated support location.

9. The kit assembly as described in claim 8, further comprising a second rope connected at a first end to said additional hook and at a second end to said lift harness independently of said first rope.

10. The kit assembly as described in claim 1, said lift harness further comprising a belt and at least one supported pulley through which the second end of said rope is engaged.

11. A method for assisting a user in ascending to an elevated support location, comprising the steps of:
attaching a first end of a rope to a base location of a weight supporting hook;
attaching an end of an elongated pole to a further base location of said hook;
raising said hook by said pole to an elevated location;
emplacing said hook over a substantially horizontally extending and elevated support location;
detaching said pole from said hook; and
securing a second end of said rope to a lift harness adapted to being worn by the user; and
winching upwards to said hook.

12. The method as described in claim 11, further comprising the step of successively extending and collapsing said pole via a plurality of individual and inter-telescoping sections.

13. The method as described in claim 11, further comprising the step of utilizing at least one additional hook in a tandem arrangement for enabling the user to successively winch up to a second and further elevated support location.

14. The method as described in claim 13, further comprising the step of providing and attaching a second rope at a first end to said additional hook and at a second end to said lift harness independently of said first rope.

15. The method as described in claim 11, further comprising the step of providing said lift harness with a belt and at least one supported pulley through which the second end of said rope is engaged.
